(19) United States
(12) Patent Application Publication
(10) Pub. No.: US 2019/0228366 A1
(43) Pub. Date: Jul. 25, 2019

(54) Method of Construction Quality Control Monitoring and Reporting

(71) Applicant: Christopher J. Nash, Charlotte, NC (US)

(72) Inventor: Christopher J. Nash, Charlotte, NC (US)

(21) Appl. No.: 16/241,101

(22) Filed: Jan. 7, 2019

Related U.S. Application Data
(60) Provisional application No. 62/619,942, filed on Jan. 22, 2018.

(51) Int. Cl. G06Q 10/06; E04B 1/00; G01S 19/51; G06F 16/904

(52) U.S. Cl. CPC G06Q 10/06395; G06F 16/904; G01S 19/51; E04B 1/00

(57) ABSTRACT

The present method and system use extremely accurate GPS technology in combination with a visual, graphic display to unify and secure the quality control and monitoring of a construction process. Utilizing a planning step and an accountable performance step, a reliable and visually understandable deliverable report is created to ensure construction quality.

This application claims the benefit of filing of U.S. Provisional Patent Application No. 62/619,942, filed Jan. 22, 2018, which is incorporated by reference herein in its entirety.

The present invention is a method for improving construction quality control and quality assurance testing and reporting. More particularly, the method combines visual display and GPS technologies to (1) plan, (2) execute, and (3) document construction materials testing (CMT) programs and processes in projects including, but not limited to, construction of dams and bridges, buildings, roads, and underground utilities (sanitary sewer, storm drainage, electricity, water supply, communications systems). The specific testing includes, but is not limited to, compaction of soils and crushed stone, asphalt and concrete paving systems, concrete and steel reinforcing for foundations and superstructures, steel and concrete building framing systems, exterior walls, roofing, structural steel and concrete fireproofing, and other building and construction components and systems required by law to meet certain design and building code requirements ensuring facilities and other improvements achieve performance standards and meet quality requirements set forth by legally binding published standards so that facilities and improvements are safe for the public to occupy and use for their intended purposes.

### BACKGROUND

The construction industry is a major contributor to the economy. However, while construction plays a significant role in a national economy, there are many risks unique to the industry. Most are inherent and outside the control of man such as weather, material and labor shortages, cyclical economies, and life safety. Other construction risks include the growing number of “construction defects” that plague the industry due to poor workmanship, inferior materials, inexperienced workers and management, environmentally friendly yet untested building materials, and CMT processes and systems, software and apps that lack structure, uniformity and standards, that are inconsistent, and most importantly that are not accountable. Defects can be contained with improved systems and processes; however, the industry has been negligent in adopting effective ways to control and mitigate occurrences, and failing to leverage technology to improve quality control and quality assurance.

There are essentially two types of defects, patent and latent. A “patent” defect is “one that is discoverable upon a reasonable inspection or “open and obvious to anyone who makes a reasonable inspection of the product”. These usually reveal themselves soon after installation of material or building component. A “latent” defect is one that cannot be discovered by a reasonable inspection. They are “hidden” from ordinary view, would not be seen or otherwise discovered merely by observation, and generally are not discovered until well after installation of a material or building component.

Construction defects are costly, waste financial and material resources, are disruptive during and post construction, and can significantly devalue real estate assets. They cause injuries and illness, can be life threatening, and the financial repercussions are not always limited to just those at fault, but also innocent parties. According to research published by a leading engineering firm engaged in claims disputes and construction defect forensics, the annual financial impact for remediating construction defects approaches $200 billion dollars domestically, or close to 12% of the $1.7 trillion construction dollars spent annually in the United States. These figures are representative of direct costs only; redesign, other professional fees, legal costs, and reconstruction. They are not inclusive of residual expenditures related to business disruption, reduced use of facilities, diminished facility efficiencies and functionality, asset devaluation, reduced investor return, and lastly added maintenance costs.

Water intrusion is another significant construction flaw. Oftentimes leaks go unnoticed, hidden inside wall cavities and in areas generally not occupied on a regular and continuing basis such as attics, basements, crawl spaces, and plumbing chases. Over time as water intrusion continues, moist conditions expand and worsen. The resulting effect is the development of mold and mildew that thrives on a bounty of available food sources such as wood framing, drywall, and insulation that remains hidden under the cover of wall cavities and unoccupied spaces threatening the wellbeing and health of inhabitants who develop allergies, infections, and respiratory ailments. Because most leaks initially are obscure, the task of determining when water intrusion began and classifying defects as either patent or latent is by no means a scientific or defined exercise, setting the stage for time consuming, lengthy, and expensive litigation procedures that are invasive and disruptive to inhabitants. The amount of court cases is well documented. If detected after the normal one-year warranty period for new construction, poses challenges for plaintiffs, well below what defendants are faced with. In most cases, the chosen defense strategy is pointing of the finger at the plaintiff alleging improper or lack of maintenance.

The bottom line is that construction defects are a significant industry problem that affects a large number of designers, builders, contractors, owners and others related to the building industry.

Current solutions for construction materials testing methods are typically presented in narrative format only, are not standardized, unplanned, and generally random. Very few have any graphic representation of some test locations and results. None of the current testing programs are truly accountable. Separate reports are provided for separate testing with no unified report or oversight. Only one existing testing program utilizes any global positioning system technology. But this existing system only uses GPS at recreational grade GPS level for general job location purposes. Accordingly, the recreational grade quality of the system means that its usefulness and accuracy is very limited.

### SUMMARY

Accordingly, it is an object of the present invention to overcome the challenges and shortcomings of existing construction quality control systems and methods. The present system uses extremely accurate GPS technology in combination with a visual, graphic display to unify and secure the quality control of the construction process. Utilizing a planning step and an accountable execution step, a reliable and visually understandable deliverable report is created to ensure a project undergoes required testing in terms of the number of tests, their frequency, and density.

In one example, a method of construction quality control monitoring and reporting comprises the steps of providing a survey grade global positioning system (GPS) device, a mobile input device, and a construction quality control and monitoring software. The first step includes preplanning a quality control program for a building construction by selecting a specific set of a plurality of quality control tests to be performed and a specific set of GPS coordinates with respect to where each of the quality control tests is to be performed. The next step is then performing the quality control tests at the GPS coordinates and entering the test results into the mobile input device, wherein the test results are saved in the construction quality control and monitoring software according to the GPS coordinates for each test. The final step is creating by the construction quality control and monitoring software a visual display accounting of the construction quality control tests, wherein the visual display is shown on the mobile input device. In this way, compliance with respect to construction quality control is able to be visually confirmed. There may be provided a central server computer, wherein the mobile input device is operatively connected to the central server, and further wherein the central server has the construction quality control and monitoring software stored in server, and the construction quality control test accounting is visually seen on the server computer. Alternatively, there is an additional step of subscribing third parties to have access to the visual display accounting of the construction quality control, wherein the third parties are selected from the group consisting of property owners, investors, designers, contractors, and consultants. The quality control tests may be selected from the group consisting of density tests during mass grading, density tests for backfill material, foundation bearing conditions, density tests for mass grading, density tests below the ground level concrete floor, steel reinforcement inspections, concrete cylinder samples, structural steel inspections, soil density tests for parking areas, soil density tests of backfill, earth and stone proof roll tests, masonry mortar samples, asphalt paving tests, asphalt paving core samples, roof inspections, building skin inspections, and structural steel and concrete fireproofing. The visual display may be presented in the same shape as the building under construction. The GPS may have an accuracy of within one centimeter horizontally and two centimeters vertically.

### BRIEF DESCRIPTION OF THE DRAWINGS

FIG. 1 is a flowchart of the steps of the planning phase pursuant to one example of the method described herein.

FIG. 2 is a flowchart of the steps of the performance phase pursuant to one example of the method described herein.

FIG. 3 is a flowchart of the steps of the reporting phase pursuant to one example of the method described herein.

FIG. 4 is a flowchart of the steps of the display phase pursuant to one example of the method described herein.

FIG. 5 is a sample of a testing chart overlaid on a building diagram before any testing is done.

FIG. 6 is a sample of a testing chart overlaid on a building diagram after testing is completed.

FIG. 7 is a sample of another testing chart showing examples of categories of information contained in the summary.

FIG. 8 is a schematic of a building footprint showing an example of soil compaction testing.

### DETAILED DESCRIPTION

The construction quality control and monitoring method and system described herein is used to ensure accountability and quality in the construction materials testing field. The present method is discussed in three basic phases including planning, performance and production of a deliverable test report.

The first step is a planning step. The method pre-plans a quality assurance program based on the requirements set forth in the plans and specifications of a specific building project and contract. These specifications may come from an architect, engineer or designer of record, a builder, a property owner or any other interested party in a construction project. And depending on the complexity and importance of a project, these specifications may come from a combination or all of the interested parties. And finally, they may be included in the template of or at the suggest of a construction materials management professional. In some jurisdictions, the International Building Code may require or suggest specific inspections that are required.

Project specification details are input into a construction quality control and monitoring software memory. This software is saved at least in a mobile input device. Each specific test and test location is input into the software, together with pass/fail or other data called for in the specification so that all the components of quality control are accounted for. The construction materials testing technician or engineer (collectively “technician”) is then able to refer to their mobile input device to direct them in terms of the specific type and location of a test to be taken. This technician is also equipped with a survey grade GPS locator. The technician is then equipped to proceed to the pre-planned GPS coordinates and record the results of tests reporting the quality status and compliance or noncompliance of all materials and systems that go into a building or structure backed by graphical representations of all required tests that is continuously updated as data is submitted.

The system employs CAD (computer aided design) technology in the planning stage to determine GPS locations of all required tests based on criteria specified in the construction documents, and GPS (Global Positioning System) technology to locate the pre-planned X, Y, & Z GPS coordinates. Reporting of test results is supplemented by visual display of the quality control test program in real time. During the planning phase of a construction project, testing criteria inclusive of (1) the number tests, (2) frequency, (3) coverage, (4) density, and (5) other project specific variables are entered in the test system creating a proposed “master as tested plan” (similar in concept to “as built” drawings) containing all pre-planned test location coordinates as dictated by project requirements.

The next phase of the construction quality control monitoring and reporting method is the performance phase. The pre-planned test location coordinates are found in the field by the technician equipped with the survey grade GPS locator. As tests are performed, the results are field recorded in the mobile input device (phone or tablet). The construction quality control and monitoring software produces graphical representations of test locations and results in 2 and 3 dimensions continually updating the “master as tested plan” as subsequent tests are conducted visually noting test results in program as either passing or failing. The program also logs the specific mobile input device so that the user of the device is accountable for their entries.

The final phase of the construction materials testing process is the graphic display and summary of an interim status or final summary of the construction quality control and monitoring testing. If the CMT technician's mobile input device is the only device containing the construction quality control and monitoring software, then the technician is able to continuously monitor and observe the progress of the testing. However, the mobile input device may be operatively connected to a central server that communicates in real time or at least frequent communication with the mobile input device. If stored on a central server, then third parties may also have access to the progress of the testing. The “as tested” reporting component affords project stakeholders instantaneous updates of the status of the construction quality control and monitoring program in “real time”, leaving no gaps, delivering a continuous and full visual accounting of a project's compliance effort. Industry standard programs currently in use are sporadic, not pre-planned, unstructured, mostly absent graphical representations of test locations, and do not provide for systems of accountability. Although a project may conclude with all test reports indicating compliance with “plans and specifications”, without accountability there is no assurance that all specifications that should have been tested were in fact tested. And if areas are overlooked, an overlooked and important question remains . . . “were the overlooked areas compliant”.

One of the important features of the process described herein is the use of an accurate global positioning system (GPS) device to ensure exact testing locations. There are three distinct grades of GPS quality and accuracy. Only survey grade GPS devices are appropriate for use with the present construction quality control and monitoring program. Each of the GPS grades is discussed below.

Recreational Grade

Most handheld GPS receivers are “smart phones” equipped with recreational grade GPS technology used primarily by those engaged in various recreational and sporting events such as running, cycling, skiing, golfing, motorcycling, boating, hiking or camping. Some models show only longitude, latitude and compass bearings, and they must be compared to a map to identify locations. Others have built-in mapping software superimposing location onto a selection of maps. Specialized maps include details for areas such as ski resorts and golf courses. Accuracy of recreational GPS receivers usually falls within plus or minus 50 feet.

Mapping Grade

The next level of accuracy for GPS is mapping grade which is divided into two sections by the USGS, commercial grade and differential grade, with handheld models available in both. Commercial grade uses only the L1 frequency and has an accuracy of about 10 feet. Again, this grade of GPS primarily is used for recreational purposes. Differential grade GPS devices use both the L1 and L2 frequencies for an accuracy of about 3 feet. A differential grade GPS device may cost more than 10 times the price of a commercial grade.

Survey Grade

The most accurate GPS devices are survey grade. These do not come in handheld models as they require two units to operate, a base station and a rover. Each piece of equipment must receive signals from at least four separate satellites for a minimum total of eight signals. The distance between the base station and rover varies, dependent upon location of the site being surveyed. Survey grade GPS devices have an accuracy range of within 1 centimeter horizontally and 2 centimeters vertically. This present system and method use GPS locators with survey grade capability.

The actual execution or performance of the construction quality method is undertaken by a field technician. The reference to a field technician is actually possibly a reference to multiple field technicians. While some technicians are expert across multiple construction fields and steps, it is equally possible that different technician experts will be involved in the quality control testing. Each technician will undertake relevant tests during the process according to their special skills. Small projects may involve only a single technician, while larger and more complicated projects will involve multiple different technicians.

A technician who is undertaking a quality control test will use a mobile device, including but not limited to a tablet or mobile phone or other electronic device, to enter test results concurrently with testing. In one example, the test results may be entered at the same time that each test is made. In another example, a technician will record the test results immediately or shortly after they are determined. It is most effective from a timeliness and efficiency perspective that the test results are entered in real time. For the purposes of this invention, “real time” shall mean that the quality control test results are entered into the software essentially contemporaneously as tests are performed, observations are made, and results are determined, or alternatively, within about a day of completion of a quality control test. As noted earlier, the specific mobile device is attributed to a particular technician so that entries are accountable to that technician and project stakeholders, and reported accordingly

In one example, the reporting system (the entry of testing results) is web based and automated so that the results of tests can be immediately transmitted to third parties such as project participants once plotted on the mobile device and input software by the CMT technician in the field. Standard procedures today require a registered professional engineer or CMT engineer of record review and approve reports before they are published, a period that can take three days to a week to complete versus the time required to perform a single test or a full report can be issued immediately or otherwise in real time after entering information or upon completion of the day's testing efforts. As subsequent tests are performed, the “as tested” plan is sequentially updated. With graphical representations of the project's CMT progress and results, third party project stakeholders are afforded an instantaneous update of the status of the program that relies on graphical versus narrative based reports, offering clarity and expeditious transmission to and review by project stakeholders. Pre-planning test points, graphical representations of test results, and the “as tested” component enable accountability, increase CMT execution and data collection and reporting efficiencies, and reduce review time. Cost savings include project management efficiency, reduced construction re-work, conflicts between the parties, and assurance a real estate asset will retain value.

The construction quality control and monitoring software is stored at least on the mobile device of a CMT technician, or if multiple technicians, then it must be stored at least on each of their mobile devices or on a shared device. For example, on a smaller project, maybe the software on the mobile devices is all that is required. However, in the example discussed earlier, it is seen that the there can be a benefit in interested third parties also having access to the CMT test results. These third parties include, but are not limited to, property owners, investors, designers, contractors, and consultants. To facilitate this review, a central server may be used to communicate with the CMT technician's mobile device. This communication may be wired or wireless. Then, the third parties may have access to the central server to be able to visually see the test results. Of course for legal and sensible reasons, the third parties or project stakeholders will not have editing privileges as that is strictly the obligation of the CMT agencies employees. For example, a CMT supervisor may have edit and entry privileges, while the property owners and investors will be prevented from all edit privileges in order to preserve the integrity of the reporting process. The central server may be used to transmit information to the third parties.

The central server may be used in the initial planning phase of the method described herein to enter the project details and specifications. The construction quality control and monitoring software may be used as a guide for use by a CMT service provider and a project manager or other third party. The central server may be a dedicated server computer, or it may be a secure cloud service. The construction quality control and monitoring software can be sold to and downloadable onto customer servers, or in another example, it may be licensed over the cloud as a software as a service.

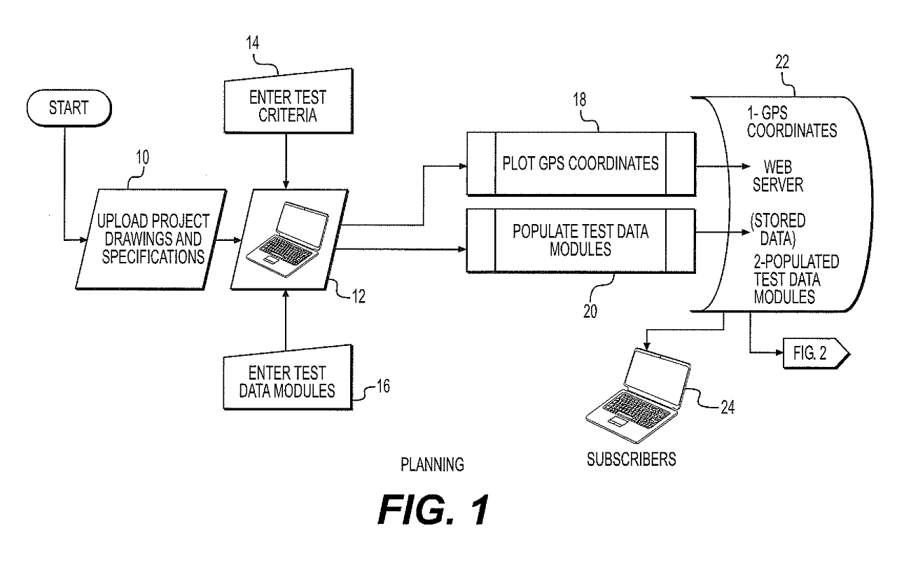

FIG. 1 is a flowchart that illustrates an example of a planning phase of the present method. Each process begins with uploading a specific quality control program for a building construction project. Drawings and specifications are input into a server computer 12 in this example. Test criteria 14 and test data modules 16 are likewise input into the central server 12. Using the construction quality control and monitoring software, the server 12 determines and plots GPS coordinates 18 and the test data modules 20. The GPS data and test data modules are then saved 22. This information may be made available to subscribers who are able to visually see the GPS and test data information.

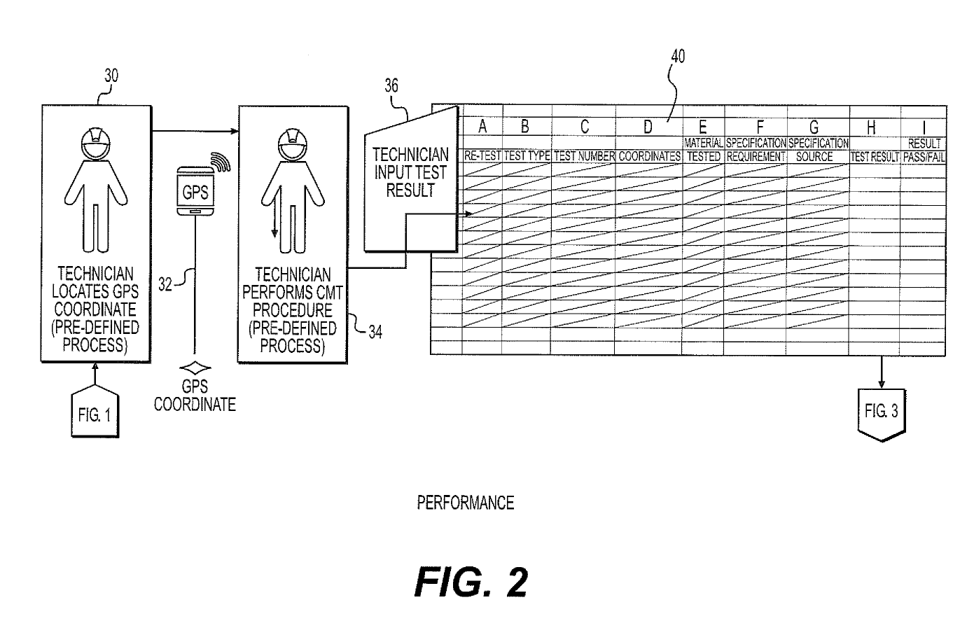

Moving along in the process to FIG. 2, a technician 30 locates the GPS coordinates for a quality control test using a survey grade GPS location device 32 and then undertakes the prescribed quality control test 34. Next, the technician enters the test result 36 into the construction quality control and monitoring software to fill out a visual display 40 of the test that was made including the details of the tests and test results. The technician will enter test results as he or she finishes each test. The tests are input into a mobile device that is operatively connected to the central server computer.

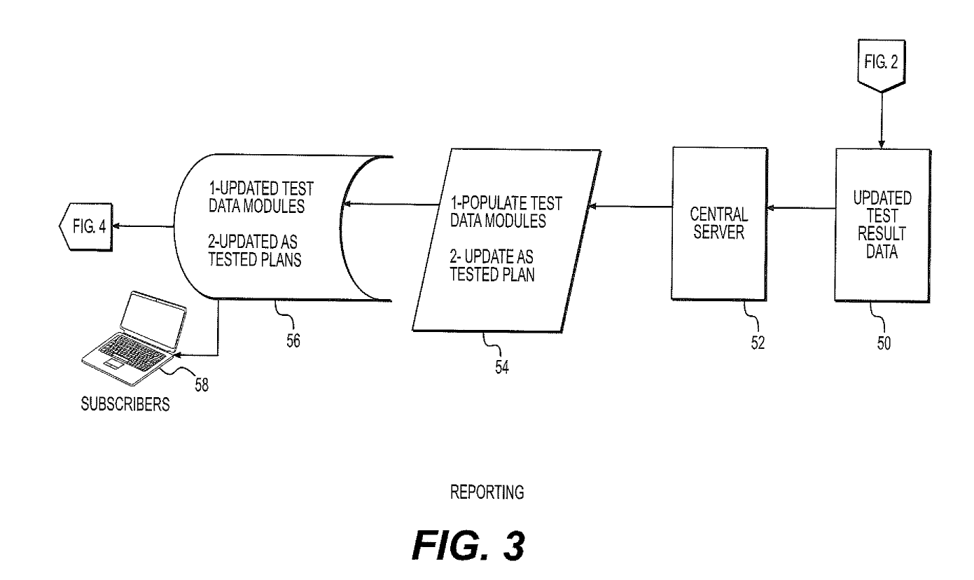

Turning now to FIG. 3, the updated test result data 50 is transmitted to the central server 52. The central server 52, using the construction quality control and monitoring software, then populates the test information and constantly updates the as tested plan and graphics 54. This test data and updated test plan 56 are saved and made available to subscribers 58.

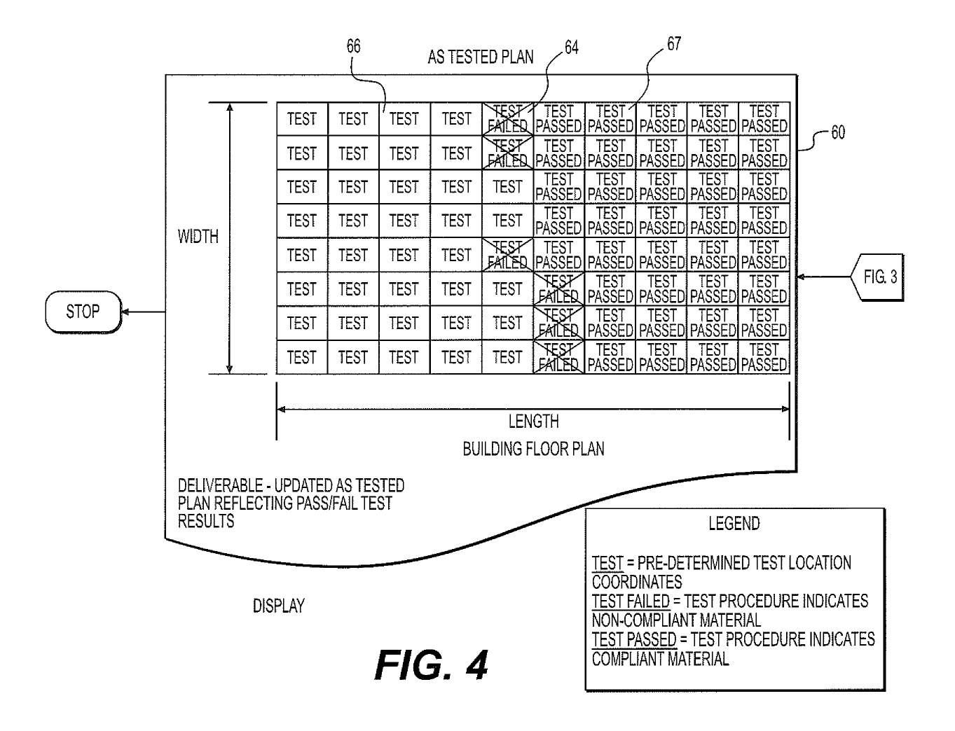

FIG. 4 is an example of an as tested plan 60. As shown, the as tested plan 60 includes the length and width dimensions of a building floor plan. The test plan 60 also displays where a quality control test is passed 67, where a test failed 64 and where (test location coordinates) tests still need to be run 66. The indicators 67, 64 and 66 are examples of the groups of test passed, test failed and test pending groupings respectively.

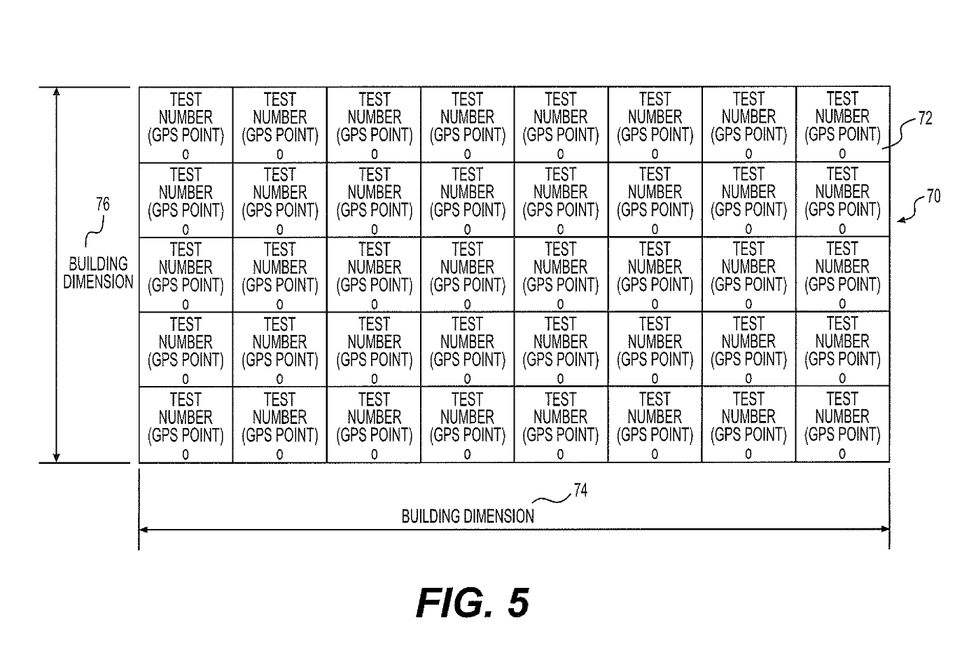

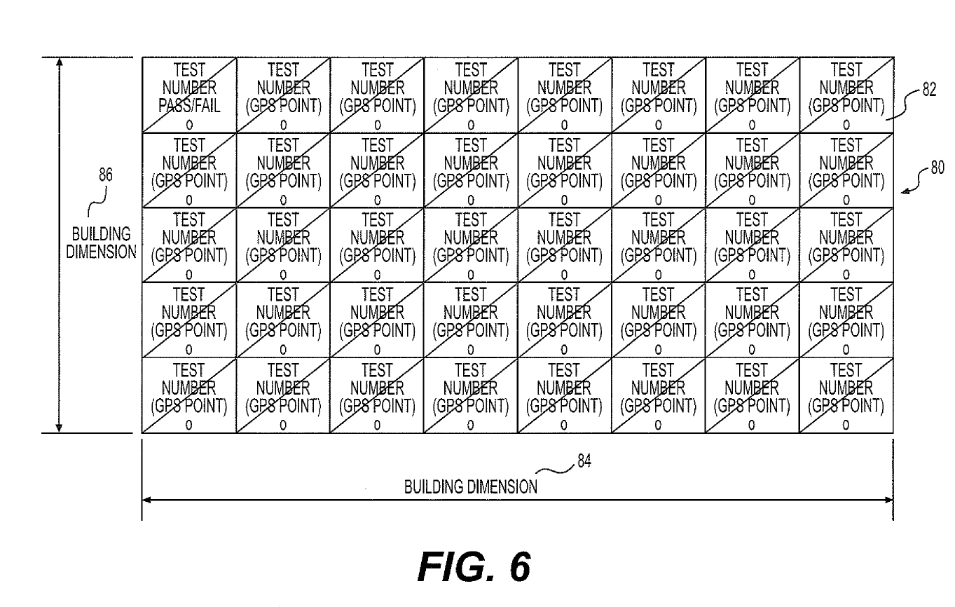

FIG. 5 is a visual display 70 of tests and coordinates 72 where they will be run in a building dimension 74 and 76. This visual display 70 makes rapid and easy the work that the technician needs to undertake. The visual display 70 is typically seen by a technician on their mobile device for easy input. FIG. 6 is similar to FIG. 5 in a visual display 80 has a grid of tests and coordinates 82 laid out by building dimensions 84 and 86. In this example of FIG. 6, however, each coordinate and test 82 is crossed out as an indication of completion of the test. This visual display 80 makes the work easy for a technician and also easy for subscribers who can watch the input tests to confirm that all required testing is completed and/or all required observations are made.

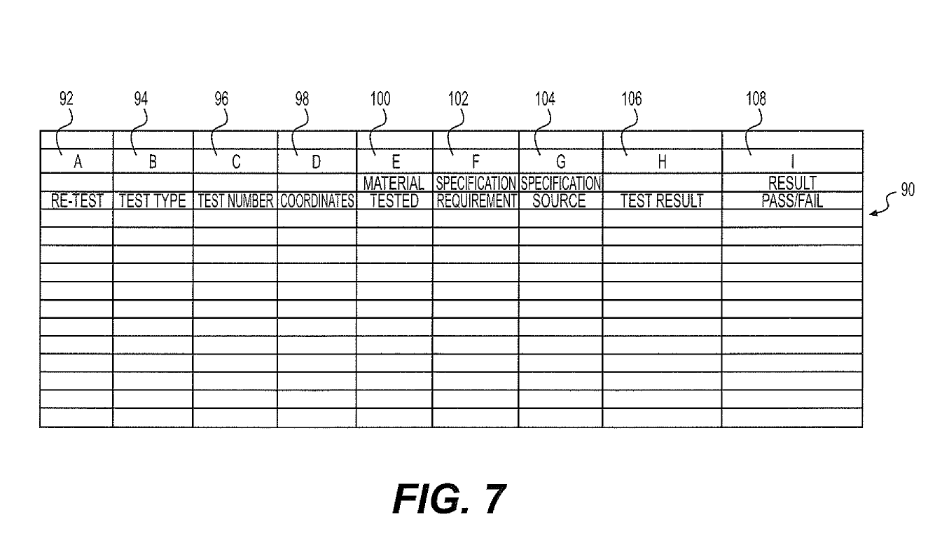

FIG. 7 illustrates a visual display 90 that sets forth categories of information and testing that may add contest and background to a test or series of tests. Pre-planning of test points, graphical representations of test results, and the “as tested” component enable accountability, increase CMT execution and data collection and reporting efficiencies, and reduce the review time. Cost savings include project management efficiency, reduced construction re-work, conflicts between the parties, and assurance a real estate asset will retain value. The columns in visual display 90 are explained in the following.

| | | |
|---|---|---|
| A | Re-Test 92 | In the case where an individual test fails, |
| | | this Column A is populated to reflect the |
| | | failed result registering the specific test as one that |
| | | will need to be re-tested after the failed area of |
| | | work is re-worked, repaired, or remediated. The |
| | | record will reflect a “re-test” was necessary. |
| | | Once remediation occurs and subsequent test(s) are |
| | | performed, if passed or failed again Column I |
| | | will display the result. If the test passes, Column |
| | | A will change color to green indicated a “go”. |
| | | If the re-test fails, Column A will indicate a |
| | | second re-test and Column H & I will be updated |
| | | accordingly. |
| B | Test Type 94 | Specific Test Types are indicated. |
| C | Test Number | Each GPS coordinate will be assigned a Test |
| | 96 | Number sequentially. Each individual test schedule |
| | | will have a number assigned. |
| D | Coordinates 98 | GPS coordinates for each test scheduled are |
| | | recorded here. |
| E | Material Tested | Specific material type. |
| | 100 | |
| F | Specification | Standards and criteria as called out in Project |
| | Requirements | Plans and Specifications and Contract Documents. |
| | 102 | |
| G | Specification | Standards set forth and adopted by |
| | Source 104 | Architectural and Engineering designers developed |
| | | and published as voluntary consensus of |
| | | technical standards for materials, products, systems, |
| | | and services. Standards called out in |
| | | Contract Documents as minimum requirements |
| | | for compliance |
| H | Test Result 106 | The CMT Field Technician will record |
| | | individual test results in this column. |
| I | Result - | Depending on the outcome of Test Results |
| | Pass/Fail 108 | recorded by the CMT Field Technician in Column H, |
| | | the system determines pass or fail by comparing H to F |

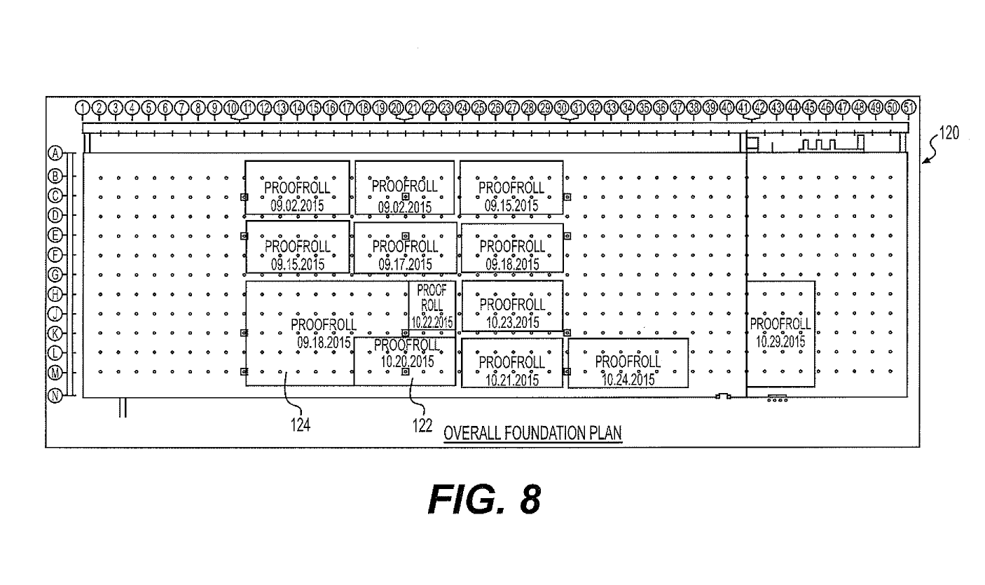

FIG. 8 illustrates a visual display 120 that shows one form of testing at an example of one site. Examples of soil compaction are shown at 122 and 124 as examples in that they show the area of testing and the date and type of testing. The alpha indicators A-N and numeric indicators 1-51 show the building site dimensions where the testing was completed.

A CMT program can involve many types of testing. There are many structures or project types where CMT tests are performed. The following list of activities is based on buildings that make up majority of construction projects in the modern world. The present method could also be deployed in connection with other building projects. A rough chronological order and the test types for a CMT program for a new building typically consists of the following activities.

1. Density Tests During Mass Grading

Soil consolidation and compaction of soil placed in the mass grading effort (removing dirt in the higher elevations for placement as fill at the lower elevations). This process involves determining density of the soil at locations and frequencies based on criteria established jointly by the Geotech Engineer and Civil Engineer.

2. Density Tests for Backfill Material

Test the backfill material that is put back in place for underground piping and other material that will be buried under concrete and asphalt paving, and/or backfill of foundations, structural and retaining walls, or other structures that are subject to placement and compaction of soil, stone, sand against vertical structures to achieve final grade parameters.

3. Foundation Bearing Conditions

Determine soil bearing conditions at the bottom of the foundation subgrade to confirm the requirements set forth by the designers and engineers of record is consistent or within the design parameters. If not, then the contractor will conduct additional compaction efforts to the bottom of foundations in order to achieve designed bearing conditions.

4. Density Tests for Mass Grading

Take samples of the fill material to determine moisture content and density relationships. If the soil is too wet or perhaps too dry, the contractor will either dry the material, or add water to arrive at the proper moisture content of the soil. The Geotechnical Study and Report contains that information and the samples gathered will produce information that tells the contractor what is needed to bring the soil to acceptable standards.

5. Density Tests Below the Ground Level Concrete Floor

Inspect the building subgrade and perform density tests to confirm the density of the soil and/or stone base below the ground level concrete floor is adequate.

6. Steel Reinforcement Inspections

Observations are made for the reinforcing steel used in the construction of foundations, walls, and elevated floors to confirm the placement and size of the reinforcing bars are correct.

7. Concrete Cylinder Samples

Take samples of the concrete that is cast for foundations, concrete floor slabs, elevated floors, retaining walls, and other concrete structures that need to meet certain standards for strength. The concrete material is place in cardboard cylinders and allowed to harden for a period of 28 days. Typically, four cylinders are cast for a certain quantity of concrete and are broken (crushed by a machine that applies pressure measured in PSI—pounds per square inch) at 7 days, 14 days, 21 days, and finally at 28 days. The concrete specifications cite the 28-day strength for those components, i.e. 3,000 psi for foundations, 4,000 psi for floor slabs as examples.

8. Structural Steel Inspections

Inspect the structural steel that comprises the skeleton or “superstructure” of a building to confirm welds are performed properly and to ensure bolts are tightened to specific torque requirements.

9. Soil Density Tests for Parking Areas

Perform density tests of the soil subgrade below parking areas, and then another series of the same tests will be conducted for the crushed stone base between the earth and the asphalt layers.

10. Soil Density Tests of Backfill

Backfill operations (placing soil back into the excavations) of underground piping for below ground utilities (storm water piping, water lines, and other underground utilities) are observed by the technician, and density tests are performed at depths and intervals specified by the engineers. This is especially important in the paved areas (concrete and asphalt) where if the fill is not compacted thoroughly, the result will be continued consolidation and subsequently settlement and failed paving.

11. Earth and Stone Proof Roll Tests

In conjunction with density testing of the soil subgrade below parking areas, the on-site technician or in some cases, the professional engineer of record will observe “proof rolls” meant to cover a broader area the single density tests don't cover to determine if there are any soft or wet areas that may settle if not properly compacted or comprised of crushed stone or earthen material with excess moisture or lack thereof. This process involves a loaded dump truck capable of handling a specific quantity and weight of the soil and a defined number of axles and wheel. The loaded dump truck rolls over an area of either soil or compacted crushed stone as the technician walks alongside the dump truck to observe if the earth or crushed stone deflects due to the mass of the load. If there is deflection, the material may be too moist, too dry, or not compacted thoroughly, or a combination thereof that would merit it not suitable to withstand anticipated loads posed by trucks and vehicles. The failed areas will be remediated by an assortment of activities specific to actual conditions or design requirements.

12. Masonry Mortar Samples

For masonry construction, samples of the mortar are made and taken back to the laboratory and crushed under controlled loads to determine compressive strength in similar fashion to 7. “concrete cylinder samples”.

13. Asphalt Paving Tests

Asphalt paving will undergo tests that confirm the temperature of the hot asphalt, the thickness of the various layers, and the density of the compacted asphalt are compliant. These density tests are like nuclear density tests performed on soil and crushed stone.

14. Asphalt Paving Core Samples

After the paving cools down, the technicians take in situ core samples of the asphalt back to the laboratory to confirm in place density and depth of the asphalt are in accordance with the specifications.

15. Roof Inspections

The roof of the building is inspected during installation to confirm the insulation for example is placed properly, the number of fasteners is sufficient, and the rubber membrane has been properly installed and/or hot welded correctly.

16. Building Skin Inspections

It is not standard procedure in construction for the “skin” (brick, precast, and window systems) to be formally inspected by technicians or engineers. Window leaks and infiltration of water into masonry, concrete, precast, or other skin material types, are major players in the world of construction defects. It is rare that a third-party inspector is retained to conduct tests and inspections as these types of observations are not a matter of law In the event there are violations, the process of determining cause and the extent of leaks followed by remediation is time consuming and very expensive. In addition, the skin can leak slowly and in quantities that are not detectable by the building inhabitants, however the exterior wall substrate and in some instances drywall is subjected to moisture allowing mold and mildew to form that can be detrimental to the health of the inhabitants. Back in the era where EIFS (exterior insulated and finish system where thin layers of cementitious material are applied over a foam substrate), for economic and design flexibility was the widespread choice of architects and owners. Leaks occurred in many buildings primarily due to unskilled labor and the lack of formal performance and inspection criteria.

17. Structural Steel & Concrete Fireproofing

Concrete and steel beams, columns, miscellaneous supports and members, and metal floor and roof decking, depending on building criteria, are spray coated with fireproofing material so that steel framing systems and reinforced concrete frames can withstand heat from fires without distorting or failing for certain periods of time generally measured in hours, or not at all, when exposed to high temperatures during a fire. To ensure the quality and performance of the sprayed fireproofing is sufficient in terms of density, thickness, and chemical and material makeup, the sprayed on fireproofing material is subject to density testing, moisture content, and thickness testing and measuring.

Other embodiments of the present invention will be apparent to those skilled in the art from consideration of the specification. It is intended that the specification and figures be considered as exemplary only, with a true scope and spirit of the invention being indicated by the claims.

That which is claimed is:

1. A method of construction quality control and monitoring comprising the steps of:
providing a survey grade global positioning system (GPS) device;
providing a mobile input device;
providing a construction quality control and monitoring software;
preplanning a quality control program for a building construction by selecting a specific set of a plurality of quality control tests to be performed and a specific set of GPS coordinates with respect to where each of the quality control tests is to be performed;
performing the quality control tests at the GPS coordinates and entering the test results into the mobile input device, wherein the test results are saved in the construction quality control and monitoring software according to the GPS coordinates for each test;
creating by the construction quality control and monitoring software a visual display accounting of the construction quality control tests, wherein the visual display is shown on the mobile input device;
whereby compliance with respect to construction quality control is able to be visually confirmed.

2. A method of construction quality control and monitoring as described in claim 1, further comprising the steps of:
providing a central server computer, wherein the mobile input device is operatively connected to the central server, and further wherein the central server has the construction quality control and monitoring software stored in server, and the construction quality control test accounting is visually seen on the server computer.

3. A method of construction quality control and monitoring as described in claim 2, further comprising the steps of:
subscribing third parties to have access to the visual display accounting of the construction quality control.

4. A method of construction quality control and monitoring as described in claim 3, wherein the third parties are selected from the group consisting of property owners, investors, designers, contractors, and consultants.

5. A method of construction quality control and monitoring as described in claim 1, wherein the quality control tests are selected from the group consisting of density tests during mass grading, density tests for backfill material, foundation bearing conditions, density tests for mass grading, density tests below the ground level concrete floor, steel reinforcement inspections, concrete cylinder samples, structural steel inspections, soil density tests for parking areas, soil density tests of backfill, earth and stone proof roll tests, masonry mortar samples, asphalt paving tests, asphalt paving core samples, roof inspections, building skin inspections, and structural steel and concrete fireproofing.

6. A method of construction quality control and monitoring as described in claim 1, wherein the visual display is presented in the same shape as the building under construction.

7. A method of construction quality control and monitoring as described in claim 1, wherein the GPS has an accuracy of within one centimeter horizontally and two centimeters vertically.
